(19) United States
(12) Patent Application Publication
(10) Pub. No.: US 2025/0048487 A1
(43) Pub. Date: Feb. 6, 2025

(54) INFORMATION PROCESSING METHODS AND APPARATUS, AND COMMUNICATION DEVICE AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 18/846,746

(22) PCT Filed: Mar. 17, 2022
(86) PCT No.: PCT/CN2022/081563

§ 371 Date: Sep. 13, 2024

(51) Int. Cl. H04W 76/27; H04W 52/14; H04W 76/28

(52) U.S. Cl. CPC H04W 76/27; H04W 52/143; H04W 76/28

(57) ABSTRACT

Information processing methods and apparatuses, and a communication device and a storage medium. An information processing method executed by a UE may comprise: when the UE is in a radio resource control (RRC) state and satisfies a preset condition, turning off a first transceiver and turning on a second transceiver, wherein the second transceiver is used for monitoring a preset signal.

### TECHNICAL FIELD

The present disclosure relates to the field of wireless communication technology but is not limited to the field of wireless communication technology, and particularly relates to an information processing method and an apparatus, a communication device and a storage medium.

### BACKGROUND

A power saving signal is introduced in the power saving project. The power saving signal may include: Downlink Control Information (DCI) for power saving (DCP) for the Radio Resource Control (RRC) connected state and Paging Early Indication (PEI) for the non-connected state. DCP and PEI are signals that UE can detect with extremely low power consumption.

If the RRC connected state UE detects DCP, it means that the Physical Downlink Control Channel (PDCCH) needs to be monitored, but if no WUS is detected, the monitoring of PDCCH is skipped.

For the discontinuous reception (DRX) scenario in the RRC idle state, the Paging Early Indication (PEI) of the power saving signal is usually configured before the Paging Occasion (PO). If the RRC idle state UE does not detect PEI, it needs to skip the monitoring of the paging DCI, otherwise it needs to monitor the paging DCI.

### SUMMARY

The embodiments of the present disclosure provide an information processing method and an apparatus, a communication device, and a storage medium.

According to a first aspect of the embodiments of the present disclosure, there is provided an information processing method, performed by a user equipment UE, where the UE includes: a first transceiver and a second transceiver; and the method includes:
when the UE is in a radio resource control RRC state and meets a preset condition, turning off the first transceiver and turning on the second transceiver, where the second transceiver is configured to monitor a preset signal.

According to a second aspect of the embodiments of the present disclosure, there is provided an information processing method, performed by a network device, where the method includes:
sending indication information or condition information of a triggering condition, where the indication information or the condition information is configured to turn off a first transceiver of a UE and turn on a second transceiver of the UE when the UE is in an RRC connected state and meets a preset condition, where the second transceiver is configured for the UE to monitor a preset signal.

According to a third aspect of the embodiments of the present disclosure, there is provided an information processing device, including a first transceiver and a second transceiver, where the device further includes:
a processing module, configured to turn off the first transceiver and turn on the second transceiver when the device is in a radio resource control RRC connected state and meets a preset condition, where the second transceiver is configured to monitor a preset signal.

According to a fourth aspect of the embodiments of the present disclosure, there is provided an information processing device, including:
a sending module, configured to send indication information or condition information of a trigger condition, wherein the indication information or the condition information is configured to turn off a first transceiver of a UE and turn on a second transceiver of the UE when the UE is in an RRC connected state and meets a preset condition, where the second transceiver is configured for the UE to monitor a preset signal.

According to a fifth aspect of the embodiments of the present disclosure, there is provided a communication device, including a processor, a transceiver, a memory, and an executable program stored on the memory and capable of being run by the processor, where the processor executes the method provided in the aforementioned first aspect or the second aspect when running the executable program.

According to a sixth aspect of the embodiments of the present disclosure, there is provided a computer storage medium, where the computer storage medium stores an executable program; after the executable program is executed by the processor, the method provided in the aforementioned first aspect or the second aspect is implemented.

In the technical solution provided by the embodiment of the present disclosure, when the UE is in the RRC connected state and the preset condition is met, the low-power second transceiver is turned on and the high-power first transceiver is turned off. In this way, on the one hand, the power consumption of the UE can be reduced as much as possible, and on the other hand, the communication abnormalities caused by the UE entering the preset mode when the preset condition is not met can be reduced.

It should be understood that the above general description and the detailed description below are only exemplary and explanatory, and cannot limit the embodiments of the present disclosure.

### BRIEF DESCRIPTION OF THE DRAWINGS

The accompanying drawings herein are incorporated into the specification and constitute a part of the specification, showing the embodiments of the present disclosure and used together with the specification to explain the principles of the embodiments of the present disclosure.

FIG. 1 is a schematic diagram of a structure of a wireless communication system according to an embodiment;

FIG. 2 is a schematic diagram of a system architecture of a policy and charging control framework according to an embodiment;

FIG. 3A is a flow diagram of an information processing method according to an embodiment;

FIG. 3B is a flow diagram of an information processing method according to an exemplary embodiment;

FIG. 4 is a flow diagram of an information processing method according to an embodiment;

FIG. 5 is a flow diagram of an information processing method according to an embodiment;

FIG. 6 is a flow diagram of an information processing method according to an embodiment;

FIG. 7 is a flow diagram of an information processing method according to an embodiment;

FIG. 8 is a schematic diagram of a structure of an information processing device according to an embodiment;

FIG. 9 is a schematic diagram of a structure of an information processing device according to an embodiment;

FIG. 10 is a schematic diagram of a structure of a UE according to an embodiment;

FIG. 11 is a schematic diagram of a structure of a communication device according to an embodiment.

### DETAILED DESCRIPTION

Here, embodiments will be described in detail, and examples thereof are shown in the accompanying drawings. When the following description refers to the drawings, unless otherwise indicated, the same numbers in different drawings represent the same or similar elements. The implementations described in the following embodiments do not represent all implementations consistent with the embodiments of the present disclosure. Instead, they are only examples of devices and methods consistent with some aspects of the embodiments of the present disclosure.

The terms used in the embodiments of the present disclosure are only for the purpose of describing specific embodiments and are not intended to limit the embodiments of the present disclosure. The singular forms “a”, “an” and “the” used in the present disclosure are also intended to include plural forms unless the context clearly indicates other meanings. It should also be understood that the term “and/or” used herein refers to and includes any or all possible combinations of one or more associated listed items.

It should be understood that although the terms first, second, third, etc. may be used to describe various information in the embodiments of the present disclosure, this information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein can be interpreted as “at the time of” or “when” or “in response to determining”.

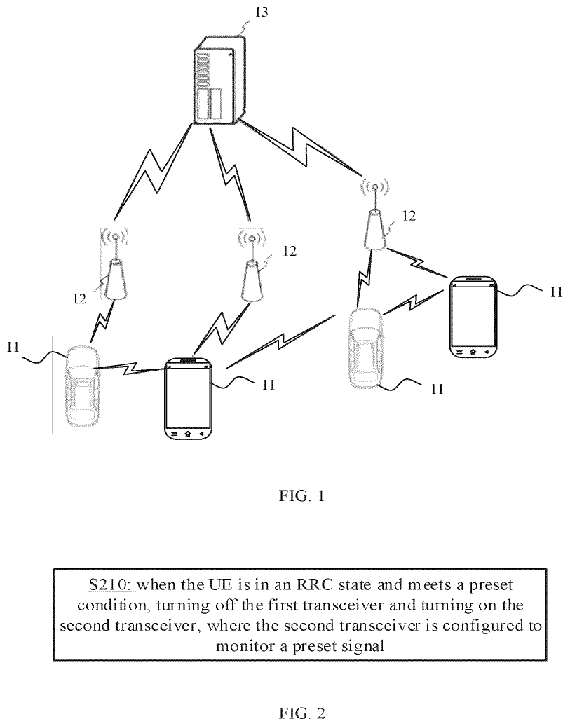

Please refer to FIG. 1, which shows a schematic diagram of a structure of a wireless communication system provided by an embodiment of the present disclosure. As shown in FIG. 1, the wireless communication system is a communication system based on cellular mobile communication technology, and the wireless communication system may include several UEs 11 and several access devices 12.

UE 11 can be a device that provides voice and/or data connectivity to users. UE 11 can communicate with one or more core networks via a radio access network (RAN). UE 11 can be an Internet of Things UE, such as a sensor device, a mobile phone (or a “cellular” phone), and a computer with an Internet of Things UE. For example, UE 11 may be a fixed, portable, pocket-sized, handheld, computer-built-in, or vehicle-mounted device. For example, UE 11 can be a station (STA), a subscriber unit, a subscriber station, a mobile station, a mobile, a remote station, an access point, a remote UE (remote terminal), an access UE (access terminal), a user terminal, a user agent, a user device, or a user UE (user equipment, UE). Alternatively, UE11 may also be a device of an unmanned aerial vehicle. Alternatively, UE11 may also be a vehicle-mounted device, for example, a driving computer with wireless communication function, or a wireless communication device connected to an external driving computer. Alternatively, UE11 may also be a roadside device, for example, a street lamp, a signal lamp or other roadside device with wireless communication function.

The access device 12 may be a network-side device in a wireless communication system. The wireless communication system may be a 4th generation mobile communication (4G) system, also known as a long term evolution (LTE) system; or, the wireless communication system may be a 5G system, also known as a new radio (NR) system or a 5G NR system. Alternatively, the wireless communication system may be a next generation system of the 5G system. The access network in the 5G system may be called NG-RAN (New Generation-Radio Access Network). Alternatively, an MTC system.

The access device 12 may be an evolved access device (eNB) used in a 4G system. Alternatively, the access device 12 may also be an access device (gNB) using a centralized distributed architecture in a 5G system. When the access device 12 uses a centralized distributed architecture, it generally includes a centralized unit (CU) and at least two distributed units (DU). The centralized unit is provided with a protocol stack of a Packet Data Convergence Protocol (PDCP) layer, a Radio Link Control (RLC) layer, and a Media Access Control (MAC) layer; the distributed unit is provided with a Physical (PHY) layer protocol stack. The specific implementation method of the access device 12 is not limited in the embodiment of the present disclosure.

A wireless connection can be established between the access device 12 and the UE 11 through a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new radio; or, the wireless air interface can also be a wireless air interface based on the next generation mobile communication network technology standard of 5G.

As shown in FIG. 2, the embodiment of the present disclosure provides an information processing method, which is performed by a user equipment UE. The UE includes a first transceiver and a second transceiver. The method includes:
S210: when the UE is in an RRC state and meets a preset condition, turning off the first transceiver and turning on the second transceiver, where the second transceiver is configured to monitor a preset signal.

The information processing method of the present disclosure is performed by a UE including a first transceiver and a second transceiver.

The UE may be various types of terminal devices, including but not limited to: a mobile phone, a tablet computer, a wearable device, an IoT device, a smart home device and/or a smart office device.

Here, “the UE is in an RRC state and meets a preset condition” means: the UE is currently in an RRC connected state, and the network connected state and/or operating state of the UE meets the preset condition.

The UE includes a first transceiver and a second transceiver. That is, the UE has at least two transceivers. The power consumption of the first transceiver in the operating state may be much greater than the power consumption required for the second transceiver in the operating state.

If the UE turns off the first transceiver and turns on the second transceiver, it can be regarded as the UE entering a preset mode (or a preset state). In this way, the preset mode can be a special power-saving operating mode of the UE.

In some embodiments, the second transceiver can be a transceiver configured only for receiving a preset signal. The preset signal may be a physical layer signal sent by an access network device such as a base station. That is, the second transceiver may be a transceiver that can only receive and decode the physical layer signal sent by the network device. The first transceiver can process and receive signaling and/or data of each layer sent by the network side. For example, the first transceiver can receive and decode a non-access stratum (NAS) message, a RRC message, a MAC layer message and/or DCI, etc.

The preset signal can be a signal that can trigger the UE to exit the preset mode, or inform the UE to prepare to exit the preset mode. For example, if the UE receives a preset signal through the second transceiver in the preset mode, according to the correspondence between the preset signal and the PDCCH, if the second transceiver monitors specific information on the PDCCH, then the UE will exit the preset mode, otherwise it will remain in the preset mode. At this time, the state in which the UE monitors the preset signal and further monitors the PDCCH corresponding to the preset signal can be understood as the state in which the UE is ready to exit the preset mode.

When the preset condition is met, the UE in the RRC connected state enters the preset mode in which the low-power second transceiver is turned on and the high-power first transceiver is turned off. In this way, on the one hand, the power consumption of the UE can be reduced as much as possible, and on the other hand, the communication abnormalities caused by the UE entering the preset mode when the preset condition is not met can be reduced.

In some embodiments, any UE in the RRC connected state and including the first transceiver and the second transceiver at the same time can enter the preset mode for saving power when the preset condition is met. However, in this embodiment, only the UE in the RRC connected state and including the first transceiver and the second transceiver at the same time and meeting a preset requirement is allowed to enter the preset mode when the preset condition is met. If the UE does not meet the preset requirement, it may be in a state of frequent data transmission. At this time, when entering the preset mode, the second transceiver cannot meet the service transmission needs of the UE. Therefore, in order to ensure that the UE enters the preset mode of power saving in a suitable communication scenario, only RRC connected state UE that includes both the first transceiver and the second transceiver and meet the preset requirement may enter the preset mode.

In one embodiment, that the UE is in the radio resource control RRC connected state and meets the preset condition includes that the UE meeting the preset requirement is in the RRC connected state and meets the preset condition.

That is, S210 may include turning off the first transceiver and turning on the second transceiver when the UE meeting the preset requirement is in the RRC state and meets the preset condition, where the second transceiver is configured to monitor the preset signal.

The UE in the RRC connected state that meets the requirement turns on the low-power second transceiver and turns off the high-power first transceiver when the preset condition is met. In this way, on the one hand, the power consumption of the UE can be reduced as much as possible, and on the other hand, the communication abnormalities caused by the UE entering the preset mode when the preset condition is not met can be reduced.

In the embodiment of the present disclosure, the UE that meets the preset requirement is a UE with low communication demand or a UE that only subscribes to a service with low communication frequency.

In some embodiments, the UE that meets the preset requirement includes at least one of the following:
the UE configured with discontinuous reception DRX;
the UE not configured with carrier aggregation; and
the UE of a predetermined type.

If the UE is not configured with discontinuous reception, the UE is very likely to have frequent service communications. Such a UE that includes both the first transceiver and the second transceiver is not a UE that meets the preset requirement.

If a UE is configured with carrier aggregation, it means that the UE has a large amount of data that requires a large bandwidth for transmission, and is also not suitable for entering the preset mode. Therefore, such a UE configured with carrier aggregation is not a UE that meets the preset requirement.

The UE of the predetermined type can be classified according to the service type configured by the UE, or according to the communication capability of the UE.

For example, some UE is only configured with a service for a low-frequency communication scenario, and it is obvious that this type of UE can be classified as the UE of the predetermined type that only has low-frequency communication demand.

For another example, some UE is designed with a special communication scenario in mind. The communication capability of such UE is relatively limited, so that the communication demand is not high. Therefore, the UE of this type can also be classified as the UE of the predetermined type.

In some embodiments, the UE of the predetermined type at least includes a reduced capability RedCap UE.

The RedCap UE may include various industrial sensors, wearable UEs or video surveillance devices.

In some other embodiments, the predetermined type of UE may also include a UE that reports to the network device that it expects to enter the aforementioned preset mode when the preset condition is met in the RRC connected state according to user input and/or device configuration.

In some other embodiments, the predetermined type of UE may also include a UE that supports the aforementioned mode. For example, the UE reports to the network device that it has the ability to work in the aforementioned preset mode according to user input and/or device configuration.

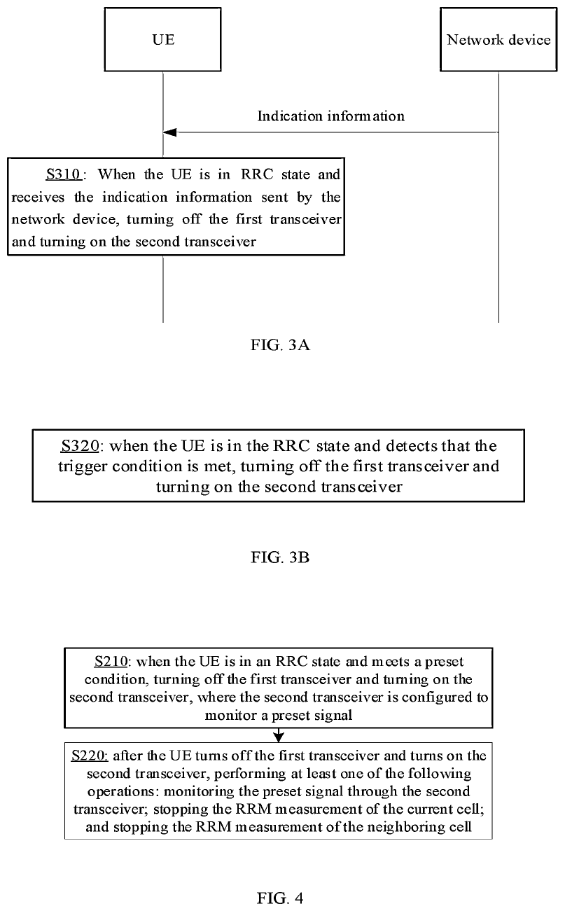

Meeting the preset condition includes at least one of the following: receiving indication information sent by the network device; meeting the trigger condition. In view of this, the information processing method of the embodiment of the present disclosure may include steps as shown in FIGS. 3A and 3B. As shown in FIG. 3A, the embodiment of the present disclosure provides an information processing method, which is performed by the UE, where the UE includes a first transceiver and a second transceiver. The method includes:
S310: When the UE is in the radio resource control RRC state and receives the indication information sent by the network device, turning off the first transceiver and turning on the second transceiver. That is, when the UE receives the indication information sent by the network device, it can be considered that the preset condition is met.

The indication information can be carried by various messages of the network device. For example, the network device such as the base station sends the indication information to the UE through DCI, MAC CE or RRC message.

The UE, upon receiving the indication information, determines that the network device determines that the UE is currently in the RRC connected state but meets the preset condition for entering the preset mode to save the power consumption of the UE.

As shown in FIG. 3B, the embodiment of the present disclosure provides an information processing method, which is performed by the UE, where the UE includes a first transceiver and a second transceiver. The method includes:
S320: when the UE is in the RRC state and detects that the trigger condition is met, turning off the first transceiver and turning on the second transceiver.

In the embodiment of the present disclosure, a UE that meets the preset requirement can determine whether the current state of the UE meets the preset condition based on the condition information of the trigger condition. If the preset condition is met, even in the RRC connected state, the UE can enter the low-power preset mode.

In this preset mode, the power consumption of the UE is lower than that of the UE in the RRC idle state with the first transceiver turned on.

In this case, the UE can determine whether the preset condition is met by itself, which has the characteristics of simple implementation, and can enter the low-power preset mode faster when the preset condition is met.

In some embodiments, the method further includes:
the UE receives the indication information during the wake-up period; for example, the UE in the RRC connected state receives the indication information during the wake-up period;
or,
the UE receives the indication information at a preset moment in the sleep period of the discontinuous reception DRX cycle; for example, the UE in the RRC connected state receives the indication information at a preset moment in the sleep period of the discontinuous reception DRX cycle.

In the embodiment of the present disclosure, the wake-up period includes at least one of the following:
the UE is configured with DRX, and the wake-up period before the UE starts DRX;
the wake-up period within the DRX cycle after the UE starts DRX;
the UE is not configured with DRX, and the UE is currently in the RRC connected state.

In all of the above cases, the first transceiver of the UE may be in the on state, at which time, the first transceiver can be configured to conveniently receive the indication information.

In some cases, the UE is configured with DRX and has started DRX. At this time, if the UE is in the sleep period of the DRX cycle, it can be configured to receive the indication information at a predetermined moment before the wake-up period. The indication information can be received by the first transceiver or by the second transceiver.

If the indication information is received at a preset moment within the sleep period, the UE knows whether it needs to enter a preset mode with lower power consumption before entering the wake-up period of the next DRX cycle, rather than entering the wake-up period of the UE's DRX cycle to wake up the first transceiver to monitor channels such as PDCCH, etc.

In some embodiments, the preset moment is the reception moment of the power saving signal.

The preset moment is the moment when the indication information is received. In the embodiment of the present disclosure, the moment when the indication information is received is configured as the moment when the power saving signal is received. In this way, when the UE is in the sleep period of the DRX cycle, the moment when the UE wakes up to monitor the downlink transmission can be reduced, thereby further saving the power consumption of the UE. For example, the power saving signal for the UE in the RRC connected state may include DCP.

In some embodiments, the trigger condition includes at least one of the following:
it is detected that the UE meets the low mobility condition;
it is detected that the UE meets the cell signal quality good condition;
it is detected that the UE meets the condition of stopping the RRM measurement of the current cell and/or the neighboring cell;
it is detected that the UE has continuously not received the downlink transmission for a preset duration; and
it is detected that the number of times the UE has continuously not received the downlink transmission reaches the number threshold.

That is, in some embodiments, turning off the first transceiver and turning on the second transceiver when detecting that the trigger condition is met includes at least one of the following:
when detecting that the UE meets the low mobility condition, turning off the first transceiver and turning on the second transceiver;
when detecting that the UE meets the cell signal quality good condition, turning off the first transceiver and turning on the second transceiver;
when detecting that the UE meets the condition of stopping the RRM measurement of the cell and/or the neighboring cell, turning off the first transceiver and turning on the second transceiver;
when detecting that the UE has continuously not received downlink transmission for a preset duration, turning off the first transceiver and turning on the second transceiver; and
when detecting that the number of times the UE has continuously not received downlink transmission reaches the number threshold, turning off the first transceiver and turning on the second transceiver.

For example, if the UE meets the low mobility condition, it means that the mobility of the UE is very low. For example, if the UE is maintained in the current area, then when there is no service data transmission, the UE has a low measurement demand for the current cell where it resides and neighboring cells of the current cell. At this time, the UE can be allowed to enter the preset mode of turning off the first transceiver and turning on the second transceiver. It is only necessary to maintain the second transceiver on and turn off the first transceiver to save the power consumption of the UE.

For example, the low mobility condition may define one or more low mobility thresholds. For example, if the UE detects that the signal quality fluctuation range of the reference signal of the current cell and/or the neighboring cell is less than the low mobility threshold, it can be considered that the low mobility condition is met.

In some embodiments, the UE's relaxed measurement will also use the low mobility condition. In some cases, the low mobility threshold of the low mobility condition used to determine whether to enter the preset mode may be equal to or greater than the low mobility threshold of the low mobility condition used by the UE's relaxed measurement.

In some embodiments, the UE detects the reference signal of the current cell and/or the neighboring cell. If the signal quality of the reference signal detected is greater than the quality threshold, it can be considered that the cell signal quality good condition is met. The UE can also reduce or stop the measurement of the reference signal of the current cell and/or the neighboring cell. In this way, it can also be considered that the preset condition is met.

In some embodiments, the UE may also be configured with a condition of stopping RRM measurement for the current cell and/or the neighboring cell. If the condition is met, it can also be considered that the condition for the UE to enter the preset mode is met.

In some embodiments, the UE has not received downlink transmission for a long time, and the UE can also enter the preset mode at this time.

The downlink transmission includes but is not limited to: downlink signaling and/or downlink data.

In some other embodiments, it is detected that the number of times the UE has continuously not received downlink transmission reaches a number threshold, and the number threshold can be a preset value. The downlink transmission is a predetermined downlink transmission, such as the transmission of PDCCH. In these two cases, it means that the UE has a small communication demand and can enter the preset mode.

In one embodiment, the method further includes:
receiving the condition information of the trigger condition sent by the network device;
or,
determining the trigger condition according to the protocol agreement.

The trigger condition can be dynamically configured by the network device or predetermined by the protocol agreement. The UE can obtain the condition information of the corresponding trigger condition as needed.

In some embodiments, the indication information includes:
a broadcast message or a dedicated message.

For example, the broadcast message includes a system message block.

When configuring the trigger condition for multiple RRC connected UEs or a RRC connected UE group, a broadcast message can be selected to send the condition information, thereby reducing the signaling consumption generated by the network device such as the base station sending the condition information separately.

If a dedicated message is used to notify the UE of the condition information, the trigger condition can be configured separately for each UE.

For example, the dedicated message includes at least one of the following:
RRC dedicated message;
media access control MAC control element CE; and
downlink control information DCI.

In some embodiments, the indication information also includes at least one of the following:
duration information, configured to determine the duration of the UE turning off the first transceiver and turning on the second transceiver; and
effective mode information, configured to determine the mode of the indication information is effective. In order to simplify the description below, the state in which the UE turns off the first transceiver and turns on the second transceiver will be referred to as the preset mode.

The duration indicated by the duration information may be the duration of the UE entering a preset mode once, or the duration of the UE entering the preset mode this time.

In some embodiments, the information indicating the effective mode indicates the effective mode of the indication information. The effective timing of the indication information is different under different effective modes.

In some embodiments, the effective mode indicated by the effective mode information includes at least one of the following:
a first effective mode, where the indication information is effective immediately after the UE receiving the indication information;
a second effective mode, where the effective time is determined according to the effective time information carried by the indication information; and
a third effective mode, where the indication information is determined to be effective after completing a predetermined event.

The first effective mode is equivalent to an immediate effective mode; the second effective mode is equivalent to a delayed effective mode; and the third effective mode is equivalent to a triggered effective mode.

In one embodiment, if the effective mode information contained in the indication information indicates that the first effective mode is adopted, the indication information will take effect immediately.

In one embodiment, if the indication information contains effective mode information indicating that the delayed effective mode is adopted, the effective time will be determined according to the effective time information carried by the indication information, or if the indication information carries the effective time information, it is considered that the current indication information adopts the second effective mode.

In some embodiments, the effective mode information includes event identification information of a predetermined event, and the effective mode of the current indication information is considered to be the third effective mode.

If the preset condition is met when the UE that meets the preset requirement and is currently in the RRC connected state detects the specific event, the UE can enter the preset mode.

The predetermined event includes:
completing the sending of feedback information of the downlink transmission of the UE.

For example, the feedback information includes, but is not limited to, Hybrid Automatic Repeat Request (HARQ) feedback information.

In some embodiments, the downlink transmission may be PDCCH transmission and/or PDSCH transmission.

In some embodiments, the downlink transmission may be semi-static transmission and/or dynamically scheduled transmission.

In some embodiments, the predetermined event includes the UE successfully decoding the downlink transmission and completing the feedback information of the downlink transmission.

In some embodiments, the predetermined event also includes but is not limited to at least one of the following:
the UE has sent all the cached data;
the feedback information of the network device for uplink transmission is received, and the feedback information indicates that the uplink transmission is successful; and
the indication that no cached data is to be received is received from the network device.

In some embodiments, the effective time information includes at least one of the following:
effective time information, configured to indicate the effective time;
effective reference time information and time offset value, configured to determine the effective time.

If the indication information includes the effective mode information indicating that the delayed effective mode is adopted, the effective time will be determined according to the effective time information carried by the indication information, or if the indication information carries the effective time information, it is considered that the current indication information adopts the delayed effective mode.

The effective time information may specifically indicate the effective start time, or the time offset between the effective start time of the indication information and the sending time of the indication information.

In some embodiments, the time unit indicated by the effective time information may be s, ms, or a time domain unit symbol such as a subframe, a time slot, a symbol or a micro-time slot.

In some embodiments, the condition information also includes:
duration information, the duration of turning off the first transceiver and turning on the second transceiver. For example, the duration information included in the condition information indicates the duration of turning off the first transceiver and turning on the second transceiver after the UE meets the trigger condition.

In some embodiments, when the RRC connected state UE that meets the preset requirement determines that the trigger condition is met and needs to enter the preset mode, it can adopt the immediate effective mode, and the UE will immediately enter the preset mode. If the delayed effective mode is adopted, the UE will enter the preset mode after a delay equal to the duration indicated by the duration information according to the duration indicated by the duration information contained in the condition information.

In some embodiments, the downlink transmission includes at least one of the following: service data;
downlink control information DCI sent by the physical downlink control channel PDCCH; and
data transmission indicated in the DCP.

The service data may include service data sent by the network device to the UE and/or service data released by the communication peer UE to the UE.

If DCI can be configured to dynamically schedule the communication of the UE, and DCI is received, it means that the UE may have data and/or instruction communication in the future, and it is not appropriate to enter the preset mode.

For example, the DCP may include 1 bit. If the value of the bit is 0, it is considered that no downlink data transmission is expected in the time period mapped by the DCP. If the value of the bit is 1, it is considered that downlink data transmission is expected in the time period mapped by the DCP.

In some embodiments, the preset signal includes a power saving signal. The power saving signal for the RRC connected state may include at least DCP. In some embodiments, the power saving signal may also include any other signal that helps the UE save power consumption, such as a physical layer signal.

As shown in FIG. 4, the embodiment of the present disclosure provides an information processing method, which is performed by a UE. The method may include:
S210: when the UE is in an RRC state and meets a preset condition, turning off the first transceiver and turning on the second transceiver, where the second transceiver is configured to monitor a preset signal;
S220: after the UE turns off the first transceiver and turns on the second transceiver, performing at least one of the following operations:
monitoring the preset signal through the second transceiver;
stopping the Radio Resource Management (RRM) measurement of the current cell; and
stopping the RRM measurement of the neighboring cell.

By stopping the RRM measurement of the current cell and/or the neighboring cell, the power consumption of the UE can obviously be saved. In addition, by monitoring the preset signal, the UE can be woken up in time when there is a communication demand on the network side, and the first transceiver with strong communication capability is turned on for communication.

In some embodiments, the method also includes:
when a wake-up event is detected, turning on the first transceiver. That is, when a wake-up event is detected, the aforementioned preset mode is exited.

For example, the UE is internally configured with event information of one or more wake-up events. If the UE currently detects that a wake-up event has occurred, the UE will exit the preset mode. After exiting the preset mode, the UE will turn on the first transceiver, so that the first transceiver is in a state capable of communicating with the network device.

For example, after exiting the preset mode, the UE enters the conventional RRC idle state, or, after exiting the preset mode, the UE initiates an RRC connection request to enter the RRC connected state, or, after exiting the preset mode, the UE enters the RRC inactive state.

In some embodiments, if the UE returns to the conventional RRC idle state or the RRC inactive state after exiting the preset mode, if the UE has an uplink communication demand locally, a request to make the UE enter the RRC connected state can be actively initiated. If the UE has no uplink communication demand locally after exiting the preset mode, the downlink transmission of the network device is monitored, and the timing for returning to the RRC connected state is determined according to the downlink transmission of the network device, or the UE returns to the preset mode upon detecting that the preset condition is met again.

In some embodiments, the wake-up event includes at least one of the following:
detecting that the UE has an uplink transmission;
detecting the need for synchronization between the UE and the network device;
detecting that the duration of the UE turning off the first transceiver and turning on the second transceiver exceeds the preset duration; and
the second receiver receiving the preset signal.

For example, if the UE locally caches data that needs to be reported to the server or the peer UE, the UE will have an uplink transmission.

Assuming that the UE is an industrial sensor, and a production abnormality is detected in the preset mode and needs to be reported immediately, then it is considered that the UE has detected an uplink transmission, so the UE is equivalent to detecting a wake-up event. After detecting the wake-up event, the UE will exit the preset mode and determine whether to actively initiate a connection request or a reconnection request based on the urgency of the uplink transmission to re-establish the RRC connection with the network device to send the uplink transmission.

In other embodiments, the UE locally determines that it has lost synchronization with the network device and needs to re-establish synchronization. At this time, it can also be considered that a wake-up event is detected.

In other embodiments, the duration of the UE entering the preset mode this time or the duration of entering the preset mode once is pre-configured. If the duration of the current UE maintained in the preset mode has exceeded the pre-configured preset duration, it can also be considered that the UE has detected a wake-up event.

If the network device has a need to wake up the UE, it will broadcast or unicast the preset signal. At this time, the second transceiver that is turned on in the preset mode will receive the preset signal. If the second transceiver receives the preset signal, it can also be considered that a wake-up event is detected.

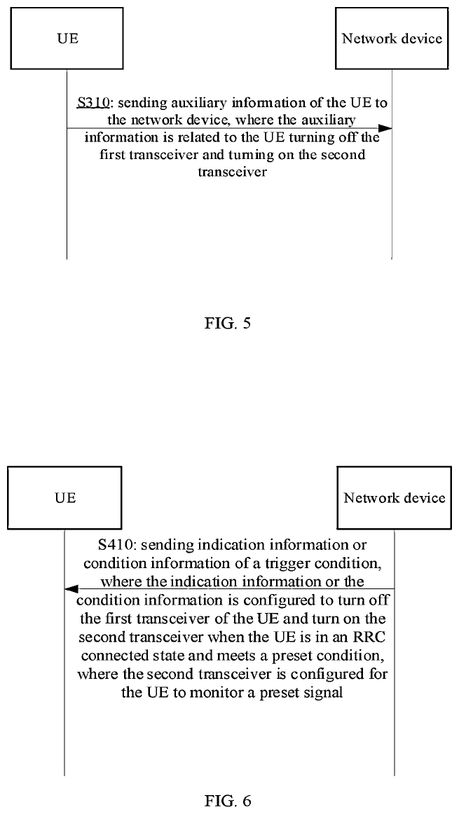

As shown in FIG. 5, the present disclosure provides an information processing method, which is performed by a UE, and the method includes:
S310: sending auxiliary information of the UE to the network device, where the auxiliary information is related to the preset mode of the UE.

In some embodiments, the UE reports its own auxiliary information to a base station or a core network device, etc. The auxiliary information is used by the network device to determine whether the UE can or is willing to enter the preset mode when the UE is in an RRC connected state and the preset condition is met, so as to facilitate the network device to control the state of the UE.

The UE may be the aforementioned UE or any other UE. The information processing method provided in this embodiment may be executed alone or in combination with any of the aforementioned embodiments.

In some embodiments, the auxiliary information includes at least one of the following:
capability information indicating whether the UE includes the first transceiver and the second transceiver.

For example, the capability information can be configured to indicate whether the UE supports entering the preset mode, or has the ability to enter the preset mode;
expectation information, configured to indicate whether the UE expects to turn off the first transceiver and turn on the second transceiver;
expected duration information configured to indicate the expected duration for the UE to turn off the first transceiver and turn on the second transceiver; and
expected condition information configured to indicate the expected triggering condition for the UE to turn off the first transceiver and turn on the second transceiver.

For example, the UE must have both the first transceiver and the second transceiver to support the preset mode, otherwise the UE does not support the preset mode.

For example, some UEs support the preset mode, but do not expect to enter the preset mode. For example, according to the historical usage data of the UE, it is found that although the UE has the ability and opportunity to enter the preset mode, the UE rarely enters the preset mode of the UE, which means that the UE may not expect to enter the preset mode.

If the UE has the ability to enter the preset mode and is willing to enter the preset mode, the auxiliary information may also include expected duration information, which is equivalent to informing the network device of the expected duration (or recommended duration) for the UE to enter the preset mode this time or the expected duration (or recommended duration) for each entry into the preset mode, so that the network device can configure the duration for the UE to enter the preset mode.

In some embodiments, the UE can also give its own expected trigger condition for entering the preset mode according to its own service characteristics, the power supply status and/or power consumption status of the UE, and report the trigger information through the expected condition information contained in the auxiliary information to the network device. In this way, after receiving the expected condition information, the network device can configure the aforementioned condition information according to the expected trigger condition of the UE and/or not according to the expected trigger condition of the UE.

As shown in FIG. 6, the embodiment of the present disclosure provides an information processing method, which is performed by a network device, wherein the method includes:
S410: sending indication information or condition information of a trigger condition, where the indication information or the condition information is configured to turn off the first transceiver of the UE and turn on the second transceiver when the UE is in an RRC connected state and meets a preset condition, where the second transceiver is configured for the UE to monitor a preset signal.

In some embodiments, a network device such as a base station performs a judgment of a trigger condition, and if the trigger condition is met, an indication information is sent to the UE.

In some other embodiments, a network device such as a base station may also send condition information of the trigger condition to the UE, and the UE determines whether the trigger condition is met, thereby determining whether to enter the preset mode.

If the condition information is sent to the UE, and the UE determines whether to enter the preset mode of turning off the first transceiver and turning on the second transceiver, before the UE determines to enter the preset mode, it may first send a report information indicating that the trigger condition for entering the preset mode is met to the base station, so that the base station will know that the UE will enter the preset mode.

For example, the indication information or the condition information is configured to turn off the first transceiver of the UE and turn on the second transceiver when the UE meeting the preset requirement is in the RRC connected state and meets the preset condition, where the second transceiver is configured for the UE to monitor the preset signal.

In the embodiment of the present disclosure, the UE meeting the preset requirements is a UE with low communication demand or a UE that only subscribes to a service with low communication frequency.

In some embodiments, the UE meeting the preset requirement includes at least one of the following:
the UE configured with discontinuous reception DRX;
the UE not configured with carrier aggregation; and
the UE of a predetermined type.

If the UE is not configured with discontinuous reception, the UE is very likely to have frequent service communications. Such a UE that includes both the first transceiver and the second transceiver is not a UE that meets the preset requirement.

If a UE is configured with carrier aggregation, it means that the UE has a large amount of data that requires a large bandwidth for transmission, and is also not suitable for entering the preset mode. Therefore, such a UE configured with carrier aggregation is not a UE that meets the preset requirement.

The predetermined type of UE can be classified according to the service type configured by the UE, or according to the communication capability of the UE.

For example, some UEs are only configured with services for low-frequency communication scenarios, and it is obvious that this type of UE can be classified as the predetermined type of UE that only has low-frequency communication demand.

For another example, some UEs are designed with special communication scenarios in mind. The communication capability of such UEs is relatively limited, so that the communication demand is not high. Therefore, this type of UE can also be classified as the predetermined type of UE.

In some embodiments, the predetermined type of UE at least includes reduced capability RedCap UE.

The RedCap UE may include various industrial sensors, wearable UEs or video surveillance devices.

In some other embodiments, the predetermined type of UE may also include the UE that reports to the network device according to user input and/or device configuration that it expects to enter the aforementioned preset mode when the preset condition is met in the RRC connected state.

In some embodiments, the method further includes:
when the UE is monitored to meet the trigger condition, determining that the UE sends the indication information.

In some other embodiments, after the network device receives the request information sent by the UE to enter the preset mode, if it is determined that there is no data sent to the UE on the current network side, it may also send the UE an indication information indicating that it enters the preset mode.

In short, the condition for the network device to send the indication information may be that the network device determines that the UE currently meets the trigger condition, or it may be based on the request of the UE.

In some embodiments, the trigger condition includes at least one of the following:
low mobility condition;
cell signal quality good condition;
the UE has continuously not received downlink transmission for a preset duration;
the base station has continuously not sent downlink transmission to the UE for a preset duration;
the number of times the UE has continuously not received downlink transmission reaches a number threshold; and
the number of times the base station has not sent downlink transmission to the UE reaches a number threshold.

For the relevant description of the trigger condition such as low mobility condition and cell signal quality good condition, please refer to the corresponding part of the above embodiment, which will not be repeated here.

After receiving the condition information of the above trigger condition, the UE will determine whether the trigger condition is met.

After the UE determines that any of the above conditions is met, it informs the base station that the above trigger condition is met; or, the base station determines whether it has continuously not sent downlink transmission to the UE for a preset duration, or the number of times it has continuously not sent downlink transmission to the UE reaches a number threshold, then the base station can know whether the trigger condition is met based on its own downlink transmission to the UE.

If the UE reports report information that meets the trigger condition, the base station can determine to send indication information to the UE based on the report information. If the base station determines whether the trigger condition is met based on its own downlink transmission to the UE, it can send the above indication information to the UE to indicate that the UE enters the preset mode when the trigger condition is met.

In some embodiments, the indication information or the condition information is carried in a broadcast message or an RRC dedicated message.

In some embodiments, the indication information or the condition information is carried in a broadcast message or a dedicated message.

For example, the broadcast message includes a system message block.

For example, the dedicated message includes at least one of the following:
RRC dedicated message;
media access control MAC control element CE; and
downlink control information DCI.

In some embodiments, the indication information also includes at least one of the following:
duration information, configured to determine the duration of the UE turning off the first transceiver and turning on the second transceiver; and
effective mode information, configured to determine the effective mode of the indication information.

The duration indicated by the duration information can be the duration of the UE entering the preset mode once, or the duration of the UE entering the preset mode this time.

In some embodiments, the information indicating the effective mode indicates the effective mode of the indication information, and the effective timing of the indication information is different under different effective modes.

In some embodiments, the effective mode indicated by the effective mode information includes at least one of the following:
a first effective mode where the indication information is effective immediately after the UE receiving the indication information;
a second effective mode where the effective time is determined according to the effective time information carried by the indication information; and
a third effective mode where the indication information is determined to be effective after completing a predetermined event.

The first effective mode is equivalent to an immediate effective mode; the second effective mode is equivalent to a delayed effective mode; and the third effective mode is equivalent to a triggered effective mode.

If the effective mode information contained in the indication information indicates that the first effective mode is adopted, the indication information will take effect immediately.

If the indication information contains effective mode information indicating that the delayed effective mode is adopted, the effective time will be determined according to the effective time information carried by the indication information, or if the indication information carries the effective time information, it is considered that the current indication information adopts the second effective mode.

If the effective mode information contains event identification information of a predetermined event, it is considered that the effective mode of the current indication information is the third effective mode.

If the preset condition is met when the UE that meets the preset requirements and is currently in the RRC connected state detects the specific event, the UE can enter the preset mode.

The predetermined event includes completing the sending of feedback information of the downlink transmission of the UE.

For example, the feedback information includes, but is not limited to, Hybrid Automatic Repeat Request (HARQ) feedback information.

In some embodiments, the downlink transmission may be PDCCH transmission and/or PDSCH transmission.

In some embodiments, the downlink transmission may be semi-static transmission and/or dynamically scheduled transmission.

In some embodiments, the predetermined event includes the UE successfully decoding the downlink transmission and completing the feedback information of the downlink transmission.

In some embodiments, the predetermined event also includes but is not limited to at least one of the following:
the UE has sent all the cached data;
the feedback information of the network device for uplink transmission is received, and the feedback information indicates that the uplink transmission is successful; and
the indication that no cached data is to be received is received from the network device.

In some embodiments, the effective time information includes at least one of the following:
effective time information, configured to indicate the effective time;
effective reference time information and time offset value, configured to determine the effective time.

In some embodiments, if the indication information includes effective mode information indicating that the delayed effective mode is adopted, the effective time will be determined according to the effective time information carried by the indication information, or if the indication information carries the effective time information, it is considered that the current indication information adopts the delayed effective mode.

The effective time information may specifically indicate the effective start time, or the time offset between the effective start time of the indication information and the sending time of the indication information.

In some embodiments, the time unit indicated by the effective time information may be s, ms, or a time domain unit symbol such as a subframe, a time slot, a symbol or a micro-time slot.

In some embodiments, the condition information also includes:
duration information, the duration of turning off the first transceiver and turning on the second transceiver. For example, the duration information included in the condition information indicates the duration of turning off the first transceiver and turning on the second transceiver after the UE meets the trigger condition.

In some embodiments, after the condition information carrying the duration information is sent, when the UE determines that the trigger condition is met and needs to enter the preset mode, it can adopt the immediate effective mode, and the UE will immediately enter the preset mode. If the delayed effective mode is adopted, the UE will be effective after a delay equal to the duration indicated by the duration information according to the duration indicated by the duration information contained in the condition information.

In some embodiments, the downlink transmission includes at least one of the following:
service data;
downlink control information DCI sent by PDCCH; and
data transmission indicated in DCP.

The service data may include service data sent by the network device to the UE and/or service data released by the communication peer UE to the UE.

If DCI can be configured to dynamically schedule the communication of the UE, and DCI is received, it means that the UE may have data and/or instruction communication in the future, and it is not appropriate to enter the preset mode.

For example, the DCP may include 1 bit. If the value of the bit is 0, it can be considered that no downlink data transmission is expected in the time period mapped by the DCP. If the value of the bit is 1, it can be considered that downlink data transmission is expected in the time period mapped by the DCP.

In some embodiments, the preset signal includes a power saving signal.

The power saving signal may at least include DCP in RRC connected state but not limited to DCP.

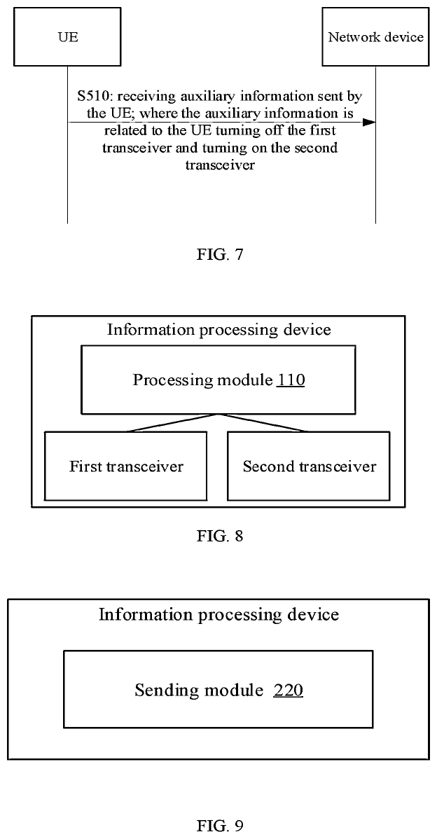

As shown in FIG. 7, the embodiment of the present disclosure provides an information processing method, which can be executed by a network device such as a base station. The method may includes:
S510: receiving auxiliary information sent by the UE; where the auxiliary information is related to the UE turning off the first transceiver and turning on the second transceiver.

The information processing method provided in this embodiment can be implemented alone or in combination with the aforementioned information processing method performed by the network device.

In some embodiments, the UE reports its own auxiliary information to a network device such as a base station or a core network device, etc. The auxiliary information is used by the network device to determine whether the UE can or is willing to enter the preset mode when the UE is in an RRC connected state and the preset condition is met, so as to facilitate the network device to control the state of the UE.

In some embodiments, the auxiliary information includes at least one of the following: capability information indicating whether the UE includes the first transceiver and the second transceiver;
expectation information, configured to indicate whether the UE expects to turn off the first transceiver and turn on the second transceiver;
expected duration information, configured to indicate the expected duration for the UE to turn off the first transceiver and turn on the second transceiver; and
expected condition information, configured to indicate the expected triggering condition for the UE to turn off the first transceiver and turn on the second transceiver.

For example, the UE must have both the first transceiver and the second transceiver to support the preset mode, otherwise the UE does not support the preset mode.

For example, some UEs support the preset mode, but they do not expect to enter the preset mode. For example, according to the historical usage data of the UE, it is found that although the UE has the ability and opportunity to enter the preset mode, the UE rarely enters the preset mode of the UE, which means that the UE may not expect to enter the preset mode.

If the UE has the ability to enter the preset mode and is willing to enter the preset mode, the auxiliary information may also include expected duration information, which is equivalent to informing the network device of the expected duration (or recommended duration) for the UE to enter the preset mode this time or the expected duration (or recommended duration) for each entry into the preset mode, so that the network device can configure the duration for the UE to enter the preset mode.

In some embodiments, the UE can also give its own expected trigger condition for entering the preset mode according to its own service characteristics, the power supply status and/or power consumption status of the UE, and report the trigger information through the expected condition information contained in the auxiliary information to the network device. In this way, after receiving the expected condition information, the network device can configure the aforementioned condition information according to the expected trigger condition of the UE and/or not according to the expected trigger condition of the UE.

The network device configures the RRC connected UE to operate using a separate transceiver. The separate transceiver is the aforementioned second transceiver.

Its separate transceiver is configured to receive a low power wake-up signal (Low power WUS). The wake-up signal is configured to wake up the main radio. The main radio is the aforementioned first transceiver. The wake-up signal here is one of the preset signals mentioned above.

The network device sends the indication information that the RRC connected UE uses a separate transceiver.

The indication information is configured to notify the UE of the preset mode where the separate transceiver is in the monitoring state and the main transceiver is turned off.

If the UE regards the preset mode of putting the separate transceiver in the monitoring state and turning off the main transceiver as a newly introduced RRC state, the instruction sent by the network device is configured for the UE to migrate to the new RRC state. The RRC state is the preset mode mentioned above, which can be called RRC pre-CDRX. CDRX is Connection Discontinuous Reception (CDRX).

The indication information can be configured to notify, in a dedicated signaling method, the UE of the preset mode where the separate transceiver is in the monitoring state and the main transceiver is turned off.

The dedicated signaling is RRC signaling, MAC CE or DCI.

For example, a special MAC CE is sent, which is specifically configured to indicate the preset mode to the UE. In the preset mode, the main transceiver is turned off and the separate transceiver is started for power-saving signal monitoring.

In some embodiments, the UE may receive the indication information during the wake-up time or the active time, and may also receive the indication information during the non-wake-up time or the sleep time (outside of active time). For example, the indication information is received at the receiving moment of the DCP.

For example, the DCP carries the indication information, and the indication information may be indicated by one or more bits in the DCI. The indication information instructs the UE to turn off the main transceiver and start a separate transceiver to monitor the power-saving signal.

The effective time of the indication information may be as follows:
one embodiment is that the indication information immediately takes effect after the UE receiving the indication information;
one implementation is that the indication information may take effect at a predetermined time point after the UE receiving the indication information. Another implementation is that the indication information takes effect after the UE monitoring the sending of a specific event. For example, after the UE sends the HARQ feedback to the network device, it enters the preset mode where a separate transceiver is separately configured to be in a monitoring state according to the indication information.

The duration of the UE entering the preset mode may be as follows:
the dedicated signaling may also carry the duration information of the UE putting the separate transceiver in the monitoring state and turning off the main transceiver; the duration information may indicate the duration of the UE entering the preset mode. The duration may also be multiplexed as the stop duration of the UE measuring the neighboring cell and/or the current cell.

In some embodiments, the network device sends the indication information of the RRC connected UE using a separate transceiver based on one of the other auxiliary information:
capability information, i.e. whether the preset mode of using a separate transceiver for monitoring is supported;
expectation information, i.e. a preference expectation of whether operating in this mode is desired; (UAI report)
expected duration information, indicating the expected duration of the UE turning off the first transceiver and turning on the second transceiver; and
expected condition information, indicating the expected trigger condition of the UE turning off the first transceiver and turning on the second transceiver.

In some embodiments, the capability information may be carried in the UE capability information element (IE) and sent to the network device. In other embodiments, the expectation information, expected duration information, and expected condition information can be carried in the user assistant information (UAI) IE and sent to the network device.

In short, one or more pieces of the above auxiliary information can be sent to the network device together, or can be carried in different IEs or messages and sent to the network device separately.

The network device configures the trigger condition for the indication information of the RRC connected UE using a separate transceiver. After completing the configuration of the trigger condition, the network device will send the condition information to the UE.

The trigger condition can be configured to notify the UE to enter the preset mode in which the separate transceiver is in the monitoring state and the main transceiver is turned off. In one embodiment, the network device can send the trigger condition for the UE to relax the measurement of the current cell and/or the neighboring cell. When the UE meets the trigger condition, the separate transceiver is in the monitoring state and the main transceiver is turned off, that is, entering the preset mode. In this case, the UE is equivalent to multiplexing the trigger condition for relaxing the measurement of the current cell and/or the neighboring cell.

In one embodiment, relaxing the measurement of the current cell and/or the neighboring cell includes: reducing the measurement frequency and/or stopping the measurement. The trigger conditions corresponding to reducing the measurement frequency and stopping the measurement may be the same or different. If they are different, the trigger condition for the UE to enter the preset mode may multiplex the trigger condition corresponding to stopping the measurement. Of course, the trigger condition for the UE to stop measuring the current cell and/or the neighboring cell is more stringent than the trigger condition for reducing the measurement frequency.

As one embodiment, the network sends the threshold of the signal quality good condition and/or the low mobility condition to the UE. For example, if the UE detects that the cell signal quality good condition and the low mobility condition configured by the base station are met, the UE turns off the main transceiver and enters the preset mode.

As one embodiment, the threshold of the good cell signal quality will be higher than the threshold corresponding to the cell signal quality good condition for the relaxation of the neighboring cell measurement.

The trigger condition is configured to notify the UE to judge the timing of entering the preset mode in which the separate transceiver is in the monitoring state and the main transceiver is turned off.

In one embodiment, the network device sends the additional requirement of the trigger condition for the UE in the RRC connected state to use a separate transceiver, and the additional requirement is equivalent to finding a UE that meets the preset requirement. The additional requirement may be as follows:

Only for UEs configured with C-DRX. For example,

The protocol stipulates the preset mode where RRC connected state UEs use a separate transceiver, which is only used for UEs configured with C-DRX.

Only for UEs not configured with carrier aggregation.

For example, the protocol stipulates the preset mode where RRC connected state UEs use a separate transceiver, which is only used for UEs not configured with carrier aggregation.

For another example, the protocol stipulates the preset mode where RRC connected state UEs use a separate transceiver, which is only used for UEs not configured with dual DRX.

For another example, a UE that meets the preset requirement is not a dual-connected UE.

For another example, a UE that meets the requirement may only be for a specific type of UE: low-cost UEs such as Redcap.

The first transceiver being awakened may be triggered by the following events:

The UE has uplink data trigger. For example, the UE needs to send a scheduling request (SR) and a random access (RA) request.

The UE needs to maintain synchronization with the network device or needs to perform network measurements.

The monitoring mode duration of using a separate transceiver pre-specified by the network device has timed out, and the UE needs to wake up the first transceiver.

The UE is awakened by a power-saving signal of low power.

As shown in FIG. 8, an embodiment of the present disclosure provides an information processing device. The device includes a first transceiver and a second transceiver, and the device further includes:

A processing module 110 is configured to turn off the first transceiver and turn on the second transceiver when the device is in a radio resource control RRC connected state and meets a preset condition, where the turned-on second transceiver is at least configured to monitor a preset signal.

In some embodiments, the device may also include a storage module for storing an instruction for controlling entry into the preset mode. The instruction is generated when it is determined that the preset condition is met.

In some embodiments, the processing module 110 may be a program module. After the program module is executed by the processor, it can realize to control the UE to enter the preset mode of turning on the second transceiver and turning off the first transceiver when the preset condition is met, so as to save the power consumption of the device at the appropriate time.

In some embodiments, the processing module 110 may be a soft-hard combination module. The soft-hard combination module includes but is not limited to various programmable arrays. The programmable arrays include but are not limited to field programmable arrays and/or complex programmable arrays.

In some other embodiments, the processing module 110 may be a pure hardware module. The pure hardware module includes but is not limited to dedicated integrated circuits.

In one embodiment, the processing module 110 is also configured to turn off the first transceiver and turn on the second transceiver when the UE that meets the preset requirement is in the radio resource control RRC connected state and meets the preset condition, where the second transceiver is configured to monitor the preset signal.

In some embodiments, the device that meets the preset requirement includes at least one of the following:
the device configured with discontinuous reception DRX;
the device not configured with carrier aggregation; and
the device of a predetermined type.

In some embodiments, the predetermined type of device at least includes a reduced capability RedCap device.

In some embodiments, meeting the preset condition includes at least one of the following:
receiving indication information sent by the network device; and
detecting that the trigger condition is met.

In some embodiments, the device further includes:
a receiving module configured to receive the indication information during the wake-up period of the device; or configured to receive the indication information at a preset moment within the sleep period of a discontinuous reception DRX cycle.

In some embodiments, the preset moment includes the moment of receiving a power saving signal.

In some embodiments, meeting the trigger condition is configured to perform at least one of the following:
detecting that the device meets a low mobility condition;
detecting that the device meets a cell signal quality good condition;
detecting that the device meets a condition to stop RRM measurement of the current cell and/or neighboring cells;
detecting that the device has continuously not received downlink transmission for a preset duration; and
detecting that the number of times the device has continuously not received downlink transmission reaches a number threshold.

In some embodiments, the device further includes:
a receiving module configured to receive condition information of the trigger condition sent by a network device; or a processing module configured to determine the trigger condition according to a protocol agreement.

In some embodiments, the indication information includes a broadcast message; or
in a dedicated message.

In some embodiments, the broadcast message includes a system message block.

In some embodiments, the dedicated message includes at least one of the following:
RRC dedicated message;
media access control MAC control element CE; and
downlink control information DCI.

In some embodiments, the indication information also includes at least one of the following:
duration information, configured to determine the duration of the device turning off the first transceiver and turning on the second transceiver; and
effective mode information, configured to determine the effective mode of the indication information.

In some embodiments, the effective mode indicated by the effective mode information includes at least one of the following:
a first effective mode where the indication information is effective immediately after the device receiving the indication information;
a second effective mode where the effective time is determined according to the effective time information carried by the indication information; and
a third effective mode where the indication information is determined to be effective after completing a predetermined event.

In some embodiments, the predetermined event includes:
completing the sending of feedback information of the downlink transmission of the device.

In some embodiments, the effective time information includes at least one of the following:
effective time information, configured to indicate the effective time; and
effective reference time information and time offset value, configured to determine the effective time.

In some embodiments, the condition information also includes:
duration information, the duration of turning off the first transceiver and turning on the second transceiver. For example, the duration information included in the condition information indicates the duration for which the device turns off the first transceiver and turns on the second transceiver after the trigger condition is met.

In some embodiments, the downlink transmission includes at least one of the following:
service data;
downlink control information DCI sent by the physical downlink control channel PDCCH; and
data transmission indicated in the DCP.

In some embodiments, the preset signal includes a power saving signal.

In some embodiments, the processing module is further configured to perform at least one of the following operations after the device turns off the first transceiver and turns on the second transceiver:
monitoring the preset signal through the second transceiver;
stopping the radio resource management RRM measurement of the current cell; and
stopping the RRM measurement of the neighboring cell.

In some embodiments, the processing module is further configured to turn on the first transceiver when a wake-up event is detected.

In some embodiments, the wake-up event includes at least one of the following:
detecting that the device has uplink transmission;
detecting the need for synchronization between the device and the network device;
detecting that the duration for which the device turns off the first transceiver and turns on the second transceiver exceeds the preset duration; and
the second transceiver receiving the preset signal.

In some embodiments, the device further includes:
a sending module configured to send auxiliary information of the device to a network device, where the auxiliary information is related to the device turning off the first transceiver and turning on the second transceiver.

In some embodiments, the auxiliary information includes at least one of the following:
capability information, configured to indicate whether the UE includes the first transceiver and the second transceiver;
expectation information, configured to indicate whether the UE has an expectation to turn off the first transceiver and turn on the second transceiver;
expected duration information, configured to indicate the expected duration for the UE to turn off the first transceiver and turn on the second transceiver; and
expected condition information, configured to indicate the expected triggering condition for the UE to turn off the first transceiver and turn on the second transceiver.

As shown in FIG. 9, an embodiment of the present disclosure provides an information processing device, and the device includes:
a sending module 220, configured to send indication information or condition information of a triggering condition, where the indication information or the condition information is configured to turn off the first transceiver of the UE and turn on the second transceiver when the UE is in an RRC connected state and meets a preset condition, where the second transceiver is used for the UE to monitor a preset signal.

The information processing device may be a base station. The base station may be an access network device such as an eNB or a gNB.

In some embodiments, the device may also include a storage module for storing indication information and/or condition information to be sent to the UE. In some embodiments, the sending module 220 may be a program module; after the program module is executed by the processor, the sending of the aforementioned indication information or condition information can be realized.

In some other embodiments, the sending module 220 may be a soft-hard combination module, and the soft-hard combination module includes but is not limited to various programmable arrays. The programmable arrays include but are not limited to field programmable arrays and/or complex programmable arrays.

In some other embodiments, the sending module 220 may be a pure hardware module. The pure hardware module includes but is not limited to a dedicated integrated circuit.

In some embodiments, that the UE is in a radio resource control RRC connected state and meets a preset condition includes that the UE meeting the preset requirement is in an RRC connected state and meets the preset condition.

In some embodiments, the indication information or the condition information is configured to turn off the first transceiver of the UE and turn on the second transceiver when the UE that meets the preset requirement is in an RRC connected state and meets the preset condition, where the second transceiver is used for the UE to monitor the preset signal.

In some embodiments, the UE that meets the preset requirement includes at least one of the following:
the UE configured with discontinuous reception DRX;
the UE not configured with carrier aggregation; and
the UE of a predetermined type.

In some embodiments, the device further includes:
a processing module configured to determine that the UE sends the indication information when monitoring that the UE meets the trigger condition.

In some embodiments, the trigger condition includes at least one of the following:
low mobility condition;
cell signal quality good condition;
the UE has continuously not received downlink transmission within a preset duration;
the base station has continuously not sent downlink transmission to the UE within a preset duration;
the number of times the UE has continuously not received downlink transmission reaches a number threshold; and
the number of times the base station has not sent downlink transmission to the UE reaches a number threshold.

In some embodiments, the indication information or the condition information is carried in a broadcast message or a dedicated message.

In some embodiments, the broadcast message includes a system message block.

In some embodiments, the dedicated message includes at least one of the following:
RRC dedicated message;
media access control MAC control element CE; and
downlink control information DCI.

In some embodiments, the indication information further includes at least one of the following:
duration information, configured to determine the duration for which the UE turns off the first transceiver and turns on the second transceiver; and
effective mode information, configured to determine the effective mode of the indication information.

In some embodiments, the effective mode indicated by the effective mode information includes at least one of the following:
a first effective mode where the indication information is effective immediately after the UE receiving the indication information;
a second effective mode where the effective time is determined according to the effective time information carried by the indication information; and
a third effective mode where the indication information is determined to be effective after completing a predetermined event.

In some embodiments, the effective time information includes at least one of the following:
effective time information, configured to indicate the effective time;
effective reference time information and time offset value, configured to determine the effective time.

In some embodiments, the condition information also includes:
duration information, indicating the duration for which the UE turns off the first transceiver and turns on the second transceiver after the trigger condition is met.

In some embodiments, the downlink transmission includes at least one of the following:
service data;
downlink control information DCI sent by the physical downlink control channel PDCCH; and
data transmission indicated in the DCP.

In some embodiments, the preset signal includes a power saving signal.

In some embodiments, the device further includes:
a receiving module configured to receive auxiliary information sent by the UE; where the auxiliary information is related to the UE turning off the first transceiver and turning on the second transceiver.

In some embodiments, the auxiliary information includes at least one of the following:
capability information, indicating whether the UE includes the first transceiver and the second transceiver;
expectation information, indicating whether the UE expects to turn off the first transceiver and turn on the second transceiver;
expected duration information, indicating the expected duration for which the UE turns off the first transceiver and turns on the second transceiver;
expected condition information, indicating the expected triggering condition for the UE to turn off the first transceiver and turn on the second transceiver.

The present disclosure provides a communication device, including:
a memory for storing processor executable instructions; and
a processor, respectively connected to the memory;
where the processor is configured to execute the information processing method provided by any of the aforementioned technical solutions.

The processor may include various types of storage media, which are non-temporary computer storage media, and can continue to memorize the information stored thereon after the communication device is powered off.

Here, the communication device includes a UE or a network element. The network element may be any one of the aforementioned first to fourth network elements.

The processor may be connected to the memory through a bus, etc., for reading an executable program stored on the memory to perform, for example, at least one of the methods shown in FIGS. 4 to 7.

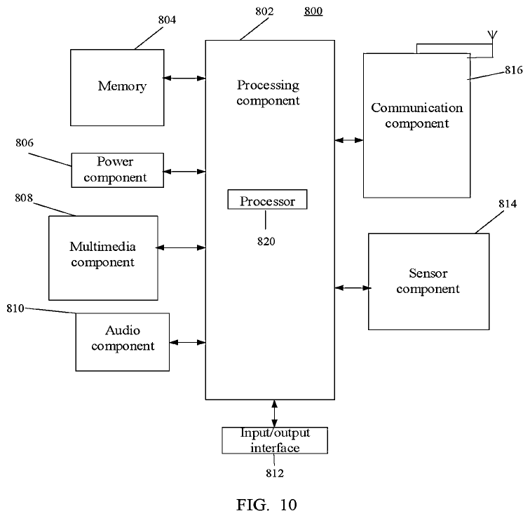

FIG. 10 is a block diagram of a UE 800 according to an embodiment. For example, the UE 800 may be a mobile phone, a computer, a digital broadcast user device, a messaging device, a game console, a tablet device, a medical device, a fitness device, a personal digital assistant, etc.

Referring to FIG. 10, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of the UE 800, such as operations associated with display, phone calls, data communications, camera operations, and recording operations. The processing component 802 may include one or more processors 820 to execute instructions to generate all or part of the steps of the above-mentioned method. In addition, the processing component 802 may include one or more modules to facilitate the interaction between the processing component 802 and other components. For example, the processing component 802 may include a multimedia module to facilitate the interaction between the multimedia component 808 and the processing component 802.

The memory 804 is configured to store various types of data to support the operation of the UE 800. Examples of such data include instructions for any application or method operating on the UE 800, contact data, phone book data, messages, pictures, videos, etc. The memory 804 can be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to various components of the UE 800. The power component 806 may include a power management system, one or more power supplies, and other components associated with generating, managing and distributing power for the UE 800.

The multimedia component 808 includes a screen that provides an output interface between the UE 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor can sense not only the boundary of the touch or slide action, but also the duration and pressure associated with the touch or slide operation. In some embodiments, the multimedia component 808 includes a front camera and/or a rear camera. When the UE 800 is in an operating mode, such as a shooting mode or a video mode, the front camera and/or the rear camera can receive external multimedia data. Each front camera and rear camera can be a fixed optical lens system or have focal length and optical zoom capabilities.

The audio component 810 is configured to output and/or input audio signals. For example, the audio component 810 includes a microphone (MIC). When the UE 800 is in an operating mode, such as a call mode, a recording mode, and a voice recognition mode, the microphone is configured to receive an external audio signal. The received audio signal can be further stored in the memory 804 or sent via the communication component 816. In some embodiments, the audio component 810 also includes a speaker for outputting audio signals.

The I/O interface 812 provides an interface between the processing component 802 and the peripheral interface module. The peripheral interface module may be a keyboard, a click wheel, a button, etc. These buttons may include, but are not limited to, a home button, a volume button, a start button, and a lock button.

The sensor component 814 includes one or more sensors for providing various aspects of status assessment for the UE 800. For example, the sensor component 814 can detect the open/closed state of the device 800, and the relative positioning of components. For example, the components are the display and keypad of the UE 800. The sensor component 814 can also detect the position change of the UE800 or the position change of a component of the UE800, the presence or absence of user contact with the UE800, the orientation or acceleration/deceleration of the UE 800, and the temperature change of the UE 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the UE 800 and other devices. The UE 800 can access a wireless network based on a communication standard, such as WiFi, 2G or 3G, or a combination thereof. In an embodiment, the communication component 816 receives a broadcast signal or broadcast-related information from an external broadcast management system via a broadcast channel. In an embodiment, the communication component 816 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the UE 800 can be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components to perform the above method.

In an embodiment, a non-transitory computer-readable storage medium including instructions is also provided, such as a memory 804 including instructions, and the instructions can be executed by the processor 820 of the UE 800 to generate the above method. For example, the non-transitory computer-readable storage medium can be a ROM, a random access memory (RAM), a CD-ROM, a tape, a floppy disk, and an optical data storage device, etc.

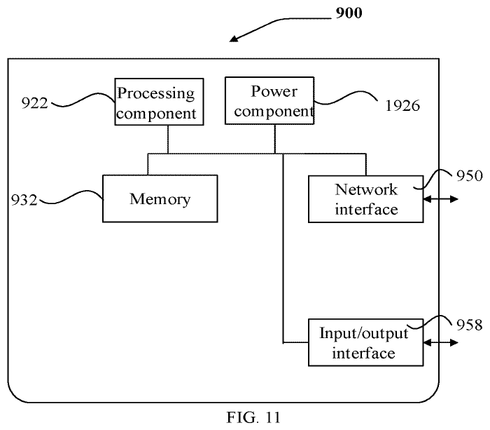

As shown in FIG. 11, an embodiment of the present disclosure shows a structure of an access device. For example, a communication device 900 can be provided as a network side device. The communication device can be various network elements such as the aforementioned access network element and/or core network element.

Referring to FIG. 11, the communication device 900 includes a processing component 922, which further includes one or more processors, and a memory resource represented by a memory 932 for storing instructions executable by the processing component 922, such as an application. The application stored in the memory 932 may include one or more modules each corresponding to a set of instructions. In addition, the processing component 922 is configured to execute instructions to execute the above method, any method of the aforementioned application in the access device, for example, the method shown in any one of FIG. 4 to FIG. 9.

The communication device 900 may also include a power component 926 configured to perform power management of the communication device 900, a wired or wireless network interface 950 configured to connect the communication device 900 to a network, and an input/output (I/O) interface 958. The communication device 900 may operate based on an operating system stored in the memory 932, such as Windows Server™, Mac OS X™, Unix™, Linux™, FreeBSD™ or the like.

Other embodiments of the present disclosure will be readily apparent to those skilled in the art after considering the specification and practicing the disclosure herein. The present disclosure is intended to cover any variation, use or adaptation of the present disclosure that follows the general principles of the present disclosure and includes common knowledge or conventional technical means in the art that are not disclosed in the present disclosure. The description and embodiments are to be regarded as exemplary only, and the true scope and spirit of the present disclosure are indicated by the following claims.

It should be understood that the present disclosure is not limited to the precise structure described above and shown in the accompanying drawings, and various modifications and changes may be made without departing from its scope. The scope of the present disclosure is limited only by the appended claims.

What is claimed is:

1. An information processing method, performed by a user equipment UE, wherein the UE comprises: a first transceiver and a second transceiver; and the method comprises:
when the UE is in a radio resource control RRC connected state and meets a preset condition, turning off the first transceiver and turning on the second transceiver, wherein the second transceiver is configured to monitor a preset signal.

2. The method according to claim 1, wherein the UE is in the radio resource control RRC connected state and meets the preset condition, comprises:
the UE that meets a preset requirement is in the RRC connected state and meets the preset condition.

3. The method according to claim 2, wherein the UE that meets the preset requirement comprises at least one of the following:
the UE configured with discontinuous reception DRX;
the UE not configured with carrier aggregation;
the UE of a predetermined type.

4. The method according to claim 1, wherein meeting the preset condition comprises at least one of the following:
receiving indication information sent by a network device;
meeting a trigger condition.

5. The method according to claim 4, wherein the method further comprises:
receiving, by the UE, the indication information within a wake-up period; or,
receiving, by the UE, the indication information at a preset moment within a sleep period of a discontinuous reception DRX cycle.

6. The method according to claim 5, wherein the preset moment is reception time of a power saving signal.

7. The method according to claim 4, wherein meeting the trigger condition comprises at least one of the following:
detecting that the UE meets a low mobility condition;
detecting that the UE meets a cell signal quality good condition;
detecting that the UE meets a condition of stopping RRM measurement of a current cell and/or a neighboring cell;
detecting that the UE has continuously not received downlink transmission for a preset duration;
detecting that a number of times the UE has continuously not received downlink transmission reaches a number threshold.

8. The method according to claim 4, wherein the method further comprises:
receiving condition information of the trigger condition sent by the network device; or,
determining the trigger condition according to a protocol agreement.

9. The method according to claim 4, wherein the indication information is contained in a broadcast message or a dedicated message.

10. The method according to claim 9, wherein the dedicated message is at least one of the following:
RRC dedicated message;
media access control MAC control element CE;
downlink control information DCI.

11. The method according to any one of claims 5, 8 to 10, wherein the indication information further comprises at least one of the following:
duration information, configured to determine a duration for which the UE turns off the first transceiver and turns on the second transceiver;
effective mode information, configured to determine an effective mode of the indication information.

12. The method according to claim 11, wherein the effective mode indicated by the effective mode information comprises at least one of the following:
a first effective mode where the indication information is effective immediately after the UE receiving the indication information;
a second effective mode where effective time is determined according to effective time information carried by the indication information;
a third effective mode where the indication information is determined to be effective after completing a predetermined event.

13. The method according to claim 12, wherein the predetermined event comprises:
completing sending of feedback information of downlink transmission of the UE.

14. The method according to claim 8, wherein the effective time information comprises at least one of the following:
effective moment information, configured to indicate an effective moment;
effective reference moment information and time offset value, configured to determine the effective moment.

15. The method according to claim 8, wherein the condition information further comprises:
duration information, configured to indicate a duration of turning off the first transceiver and turning on the second transceiver.

16. The method according to claim 7, wherein the downlink transmission comprises at least one of the following:
service data;
downlink control information DCI sent by a physical downlink control channel PDCCH;
data transmission indicated in downlink control information for power saving DCP.

17. The method according to claim 1, wherein the preset signal comprises a power saving signal.

18. The method according to claim 1, wherein the method further comprises:
after turning off, by the UE, the first transceiver and turning on the second transceiver, performing at least one of the following operations:
monitoring the preset signal through the second transceiver;
stopping radio resource management RRM measurement of a current cell;
stopping the RRM measurement of a neighboring cell.

19. The method according to any one of claims 1 to 18, wherein the method further comprises:
when a wake-up event is detected, turning on the first transceiver.

20. The method according to claim 19, wherein the wake-up event comprises at least one of the following:
detecting that the UE has uplink transmission;
detecting a need for synchronization between the UE and a network device;
detecting that a duration for which the UE turns off the first transceiver and turns on the second transceiver exceeds a preset duration;
receiving, by the second receiver, the preset signal.

21. The method according to any one of claims 1 to 20, wherein the method further comprises:
sending auxiliary information of the UE to a network device, wherein the auxiliary information is related to the preset mode of the UE.

22. The method according to claim 21, wherein the auxiliary information comprises at least one of the following:
capability information, configured to indicate whether the UE comprises the first transceiver and the second transceiver;
expectation information, configured to indicate whether the UE has an expectation to turn off the first transceiver and turn on the second transceiver;
expected duration information, configured to indicate an expected duration for the UE to turn off the first transceiver and turn on the second transceiver;
expected condition information, configured to indicate an expected triggering condition for the UE to turn off the first transceiver and turn on the second transceiver.

23. An information processing method, performed by a network device, wherein the method comprises:
sending indication information or condition information of a triggering condition, wherein the indication information or the condition information is configured to turn off a first transceiver of a UE and turn on a second transceiver of the UE when the UE is in an RRC connected state and meets a preset condition, wherein the second transceiver is configured for the UE to monitor a preset signal.

24. The method according to claim 23, wherein the indication information or the condition information is configured to turn off the first transceiver of the UE and turn on the second transceiver when the UE that meets a preset requirement is in the RRC connected state and meets the preset condition.

25. The method according to claim 23 or 24, wherein the method further comprises:
when monitoring that the UE meets the trigger condition, determining that the UE sends the indication information.

26. The method according to any one of claims 23 to 25, wherein the trigger condition comprises at least one of the following:
a low mobility condition;
a cell signal quality good condition;
the UE has continuously not received downlink transmission for a preset duration;
a base station has continuously not sent downlink transmission to the UE for a preset duration;
a number of times the UE has continuously not received downlink transmission reaches a number threshold;
a number of times the base station has not sent downlink transmission to the UE reaches a number threshold.

27. The method according to any one of claims 23 to 26, wherein the indication information or the condition information is carried in a broadcast message or a dedicated message.

28. The method according to claim 27, wherein the dedicated message comprises at least one of the following:
a RRC dedicated message;
a media access control MAC control element CE;
downlink control information DCI.

29. The method according to any one of claims 23 to 28, wherein the indication information further comprises at least one of the following:
duration information, configured to determine a duration for which the UE turns off the first transceiver and turns on the second transceiver;
effective mode information, configured to determine an effective mode of the indication information.

30. The method according to claim 29, wherein the effective mode indicated by the effective mode information comprises at least one of the following:
a first effective mode where the indication information is effective immediately after the UE receiving the indication information;
a second effective mode where effective time is determined according to effective time information carried by the indication information;
a third effective mode where the indication information is determined to be effective after completing a predetermined event.

31. The method according to claim 30, wherein the effective time information comprises at least one of the following:
effective moment information, configured to indicate an effective moment;
effective reference moment information and time offset value, configured to determine the effective moment.

32. The method according to any one of claims 23 to 31, wherein the condition information further comprises:
duration information indicating a duration of turning off the first transceiver and turning on the second transceiver.

33. The method according to any one of claims 26 to 33, wherein the downlink transmission comprises at least one of the following:
service data;
downlink control information DCI sent by a physical downlink control channel PDCCH;
data transmission indicated in downlink control information for power saving DCP.

34. The method according to claim 23, wherein the preset signal comprises a power saving signal.

35. The method according to any one of claims 23 to 34, wherein the method further comprises:
receiving auxiliary information sent by the UE; wherein the auxiliary information is related to the UE turning off the first transceiver and turning on the second transceiver.

36. The method according to claim 35, wherein the auxiliary information comprises at least one of the following:
capability information, configured to indicate whether the UE comprises the first transceiver and the second transceiver;
expectation information, configured to indicate whether the UE has an expectation to turn off the first transceiver and turn on the second transceiver;
expected duration information, configured to indicate an expected duration for the UE to turn off the first transceiver and turn on the second transceiver;
expected condition information, configured to indicate an expected triggering condition for the UE to turn off the first transceiver and turn on the second transceiver.

37. An information processing device, comprising a first transceiver and a second transceiver, wherein the device further comprises:
a processing module, configured to turn off the first transceiver and turn on the second transceiver when the device is in a radio resource control RRC connected state and meets a preset condition, wherein the second transceiver is configured to monitor a preset signal.

38. An information processing device, comprising:
a sending module, configured to send indication information or condition information of a trigger condition, wherein the indication information or the condition information is configured to turn off a first transceiver of a UE and turn on a second transceiver of the UE when the UE is in an RRC connected state and meets a preset condition, wherein the second transceiver is configured for the UE to monitor a preset signal.

39. A communication device, comprising a processor, a transceiver, a memory, and an executable program stored on the memory and capable of being run by the processor, wherein the processor executes the method provided in any one of claims 1 to 22 or 23 to 36 when running the executable program.

40. A computer storage medium, wherein the computer storage medium stores an executable program; after the executable program is executed by the processor, the method provided in any one of claims 1 to 22 or 23 to 36 is implemented.
